(19) United States
(12) Patent Application Publication
(10) Pub. No.: US 2017/0286633 A1
(43) Pub. Date: Oct. 5, 2017

(54) PROXIMITY FEEDBACK FOR MEDICINE IDENTIFICATION

(71) Applicant: International Business Machines Corporation, Armonk, NY (US)

(72) Inventors: Maryam Ashoori, White Plains, NY (US); Benjamin D. Briggs, Waterford, NY (US); Lawrence A. Clevenger, LaGrangeville, NY (US); Leigh Anne H. Clevenger, Rhinebeck, NY (US); Jonathan H. Connell, II, Cortlandt Manor, NY (US); Nalini K. Ratha, Yorktown Heights, NY (US); Michael Rizzolo, Albany, NY (US)

(21) Appl. No.: 15/085,938

(22) Filed: Mar. 30, 2016

(51) Int. Cl. G06F 19/00

(52) U.S. Cl. CPC G06F 19/3456; G06F 19/3406

(57) ABSTRACT

Embodiments include method, systems and computer program products for proximity feedback for medication identification. Aspects include accessing, via a user device, a profile data for the user; reading, via the user device, identification data from an identification tag on an object; obtaining information associated with the identification data, wherein the information is associated with contents of the object; and providing a feedback to the user via the user device, the feedback is based upon the information and an interaction between the user of the user device and the object.

### BACKGROUND

The present disclosure relates to medication compliance, and more specifically, to methods, systems, and computer program products for proximity feedback for medicine identification.

Senior citizens often have problems related to taking the correct type and correct dosage of their prescribed medications. Additionally, senior citizens may have difficulty remembering if they already took their prescribed medications.

Proper medicine identification is important for medicine compliance for patients that take one or more medications. Additionally, taking medications at the appropriate time and at the appropriate intervals also contributes to medication compliance. For example, a patient would benefit from knowing what medications to take and at what times as well as if they have already taken their medications for the day.

### SUMMARY

Embodiments include a computer system for proximity feedback for medicine identification, the computer system for a proximity feedback for medicine identification having a processor configured to perform a method. The method includes accessing, via a user device, a profile data for the user; reading, via the user device, identification data from an identification tag on an object; obtaining information associated with the identification data, wherein the information is associated with contents of the object; and providing a feedback to the user via the user device, the feedback is based upon the information and an interaction between the user of the user device and the object.

Embodiments also include a computer program product for proximity feedback for medicine identification, the computer program product including a non-transitory computer readable storage medium having computer readable program code embodied therewith. The computer readable program code including computer readable program code configured to perform a method. The method includes accessing, via a user device, a profile data for the user; reading, via the user device, identification data from an identification tag on an object; obtaining information associated with the identification data, wherein the information is associated with contents of the object; and providing a feedback to the user via the user device, the feedback is based upon the information and an interaction between the user of the user device and the object.

Embodiments also include a method for proximity feedback for medicine identification. The method includes accessing, via a user device, a profile data for the user; reading, via the user device, identification data from an identification tag on an object; obtaining information associated with the identification data, wherein the information is associated with contents of the object; and providing a feedback to the user via the user device, the feedback is based upon the information and an interaction between the user of the user device and the object.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 illustrates a block diagram of a computing system for use in practicing the teachings herein;

FIG. 4 illustrates a block diagram of a system for providing proximity feedback for medicine identification in accordance with an embodiment;

FIG. 5 illustrates a flow diagram of a method for providing proximity feedback for medicine identification in accordance with an embodiment; and

FIG. 6 illustrates a flow diagram of a method for providing proximity feedback for medicine identification in accordance with an embodiment.

### DETAILED DESCRIPTION

In accordance with exemplary embodiments of the disclosure, methods, systems and computer program products for providing proximity feedback for medication identification are provided. In exemplary embodiments, a system for providing proximity feedback for medicine identification includes a user device configured to read a radio frequency identification (RFID) tag that is affixed to an object, such as a medication container. In exemplary embodiments, the RFID tag will contain identification data regarding the contents of the object, in this case, a medication container. The identification data contained within the RFID tag allows the user device to identify the type of medication found in the object. The user device reads the RFID tag and uses this identification data along with the interaction between the user device and the object to send a feedback signal to the user. The interaction can include the movement of grabbing and turning the medication bottle or it could include being within a certain proximity of the medication bottle. The feedback signal would indicate to a user of the user device that the medication is proper or if it is improper by sending a feedback signal to the user, such as a haptic, visual or audio signal.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

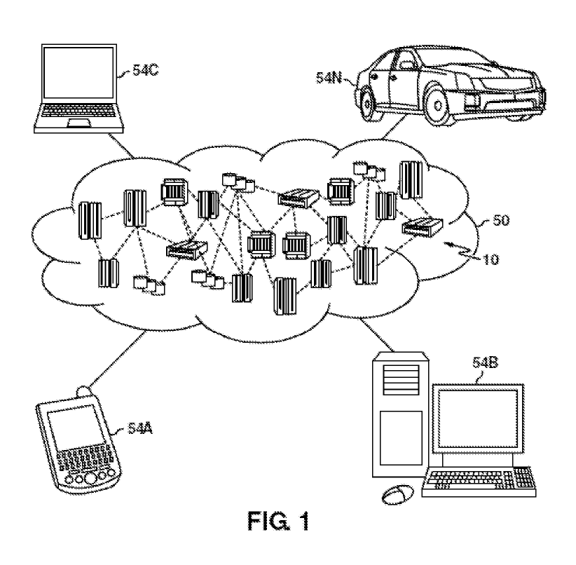

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

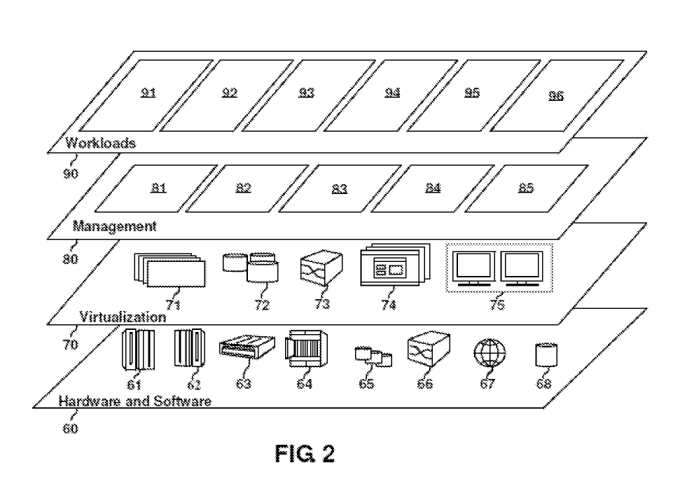

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and action analytics and notifications 96.

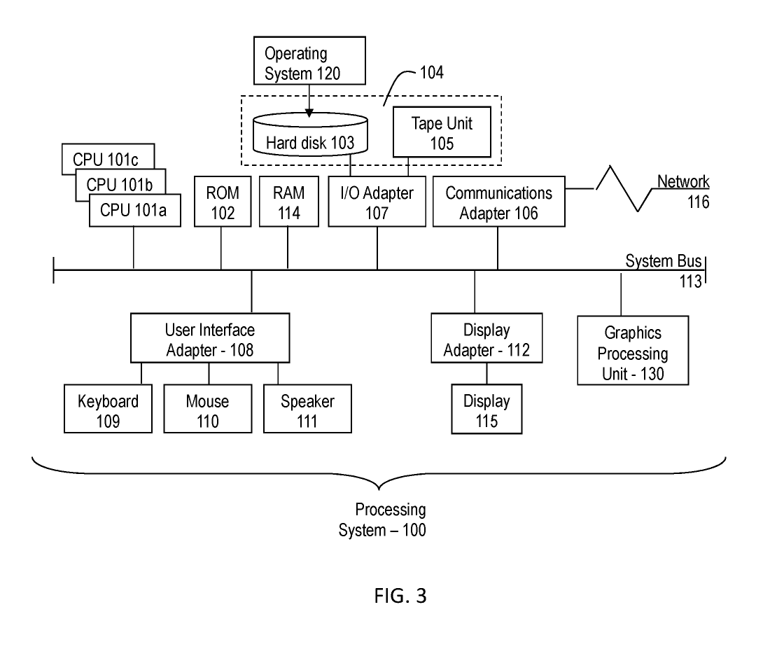

Referring to FIG. 3, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including the system memory 114 and mass storage 104, input means such as keyboard 109 and mouse 110, and output capability including speaker 111 and display 115. In one embodiment, a portion of system memory 114 and mass storage 104 collectively store an operating system coordinate the functions of the various components shown in FIG. 3.

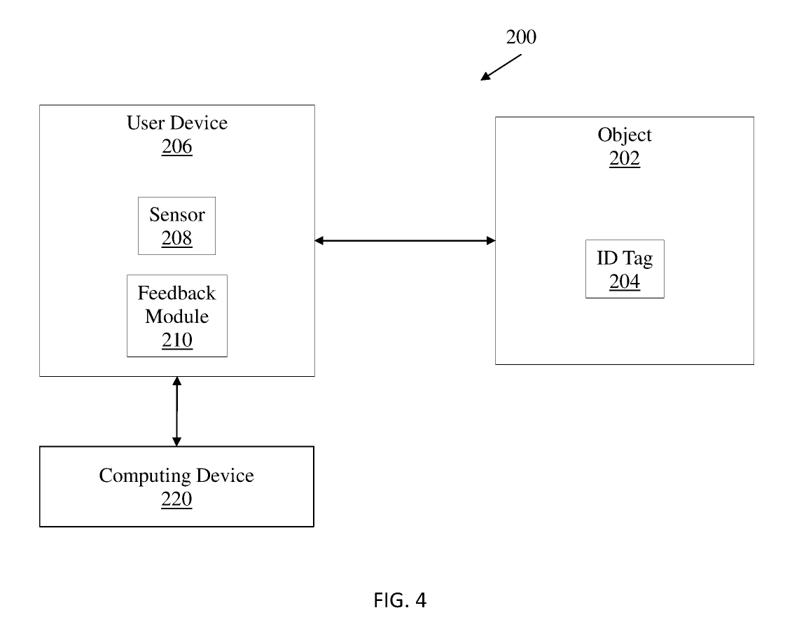

Referring to FIG. 4 there is shown an embodiment of a system 200 for providing proximity feedback for medicine identification according to aspects of the present disclosure. As illustrated, the system 200 includes a user device 206, a computing device 220, and an object 202.

In exemplary embodiments, the object 202 includes an identification (ID) tag 204. In an embodiment, the identification tag can be electronic or non-electronic. Exemplary embodiments of an electronic identification tag include a radio frequency identification (RFID) tag, a near-field communication (NFC) tag, or other similar tag. Exemplary embodiments of a non-electronic tag are one dimensional and two dimensional barcodes and optical character recognition on the object 202. The object 202 may be a prescription medicine bottle, a vitamin supplement bottle, a pill box, or any other type of container for storing medicine or supplements either in pill form or liquid form. In an embodiment, the ID tag 204 is a passive RFID tag that can be affixed to the object 202. In an embodiment, the ID tag 204 is used to store an identification data that is associated with the contents of the object. For example, the ID tag 204 would be associated with medical information such as a medicine name, dosage information, and dosage schedule for the patient, drug interactions, quantity contained within the object 202 and a patient's medical history. For example, a dosage schedule for the patient can include the time of day to take a dose of the medicine, the number of times to take a dose of the medicine, and whether to take the dose of medicine with or without food.

The system 200 also includes a user device 206 that has a sensor 208 and a feedback module 210. The sensor 208 can read the ID tag 204 to retrieve the identification data pertaining to the contents of the object 202. This identification data may contain a number associated with the contents of the object and any relevant information regarding the contents of the object 202 and will determine the course of action for a user of the user device 206 with respect to the object 202. The user device 206 may be a smart watch, an electronic wristband, or any other electronic device such as a cell phone that possesses a sensor 208 that is capable of reading the ID tag 204. In an embodiment, the user device 206 is a device that a user is constantly wearing. Also, the feedback module 210 is capable of delivering a positive or negative feedback to a user of the user device 206 in response to the interactions between the user device 206 and the object 202. This positive or negative feedback can be in the form of a haptic (vibration), audio, or visual feedback to the user of the user device 206. The system 200 also includes a computing device 220 which can interact with the user device 206 to retrieve or store information related to the user devices 206 interactions with the object 202. The computing device 220 may store data that identifies a medication found within the object 202. For example, the user device 206 reads the ID tag 204 on an object 202 and retrieves a number. This number can then be communicated to the computing device to identify the contents of the object 202, i.e. the medication. Also, the user device 206 may download a profile from the computing which can contain information about the user's medication, medication schedule, drug interactions and any medication restrictions. Additionally, the computing device 220 can be a smart phone, a computer, laptop, server, or any other device that can communicate with the user device 206 via a wired or wireless connection or may not be in direct electronic communication. For example, the user device 206 may access data from the computing device 220 via a cloud connection.

In an embodiment, a user of the user device 206 would use the system 200 for medication compliance. The object 202 can represent multiple objects such as prescription medication bottles that are prescribed to the user of the user device 206. In an example, the user device 206 is a smartwatch (constantly worn by the user) that contains a sensor 208 capable of reading the ID tag 204 (which can include technology such as RFID, near field communication, 1 and 2 dimensional barcodes, and optical character recognition of the prescription label) on the user's multiple prescription medication bottles. When the user gets within a threshold proximity of the ID tag 204 on the prescription bottle, the smartwatch retrieves the identification data contained within the ID tag 204 regarding prescription schedule. This identification data identifies the medication and can compare this information to a patient profile that is accessed via the user device 206. The patient profile contains data regarding patient's medications, such as a schedule for taking the medication. If the medication schedule is in compliance with the correct time of day and date for the user, the feedback module 210 on the smartwatch will send a positive feedback to the user in the form of a vibration, sound or visual signal to indicate that the user should take the prescribed medication at the time. However, should the prescription schedule conflict with the time and date, a negative feedback signal will be sent to the user to inform the user that they should not take the medication. The smartwatch will update the medication schedule either locally on the smartwatch or update the schedule on the computing device 220, or both.

In another embodiment, the user device 206 records previous interactions with the object 202. In the case of the medicine bottle, the user device 206 records previous interactions with the same medicine bottle. When the user device 206 reads the ID tag 204 to retrieve the identification information, the previous interaction as found in the profile data will indicate that the user has already taken their prescribed dose of medicine for the day and will send a negative feedback signal to indicate to the user they should not take the medication again. The previous interactions with the object 202 as mention above can be determined based on accelerometers, gyroscopes, and/or inclinometers contained within the user device 206. For example, the motion of opening a medicine bottle and taking the medicine can be identified by the accelerometer, gyroscope, and/or inclinometer to indicate the user is taking the medication. The time of this motion is recorded in the user device and saved to guide later interactions with the medicine bottle or object 202. This information can be communicated to the computing device 220 via the user device 206.

In yet another embodiment, the user device 206 such as a smartwatch can prompt a user at a certain time during the day to take a medication. The user's medication schedule is stored on the smartwatch and when it is time for a user to take his or her medication, the smartwatch may prompt via a positive or negative feedback to take the medication. When the user comes into proximity to the object 202 (i.e. medication bottle), the smartwatch reads the ID tag 204 and determines that the correct medication is present and provides a positive feedback to the user. If the incorrect medication is present, the smartwatch would provide a negative feedback to the user to prompt the user to obtain the correct medication according to the medication schedule.

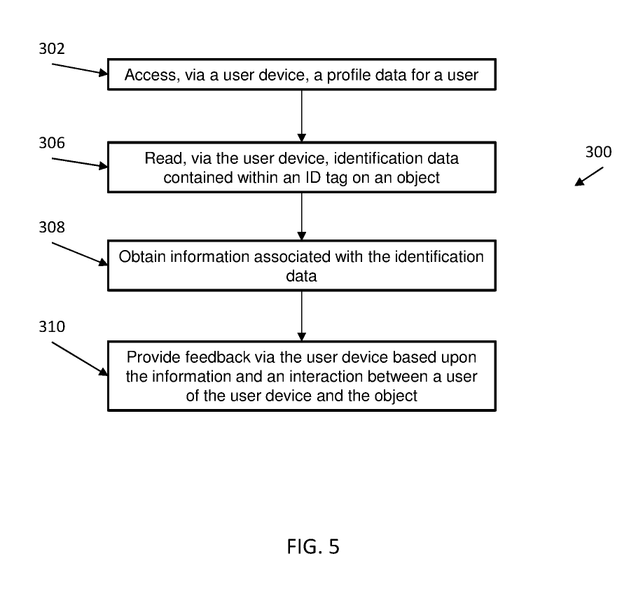

Referring now to FIG. 5 there is shown a flow diagram of a method 300 for providing proximity feedback for medicine identification. At block 302, the method 300 accesses, via a user device, a profile data for a user. Next, at block 306, the method 300 reads, via the user device, identification data contained within an ID on an object. At block 308, the method 300 obtains information associated with identification data. At block 310, the method 300 provides feedback via the user device based upon the information contained within the ID tag and an interaction between a user of the user device and the object.

Additional processes may also be included. It should be understood that the processes depicted in FIG. 5 represent illustrations, and that other processes may be added or existing processes may be removed, modified, or rearranged without departing from the scope and spirit of the present disclosure.

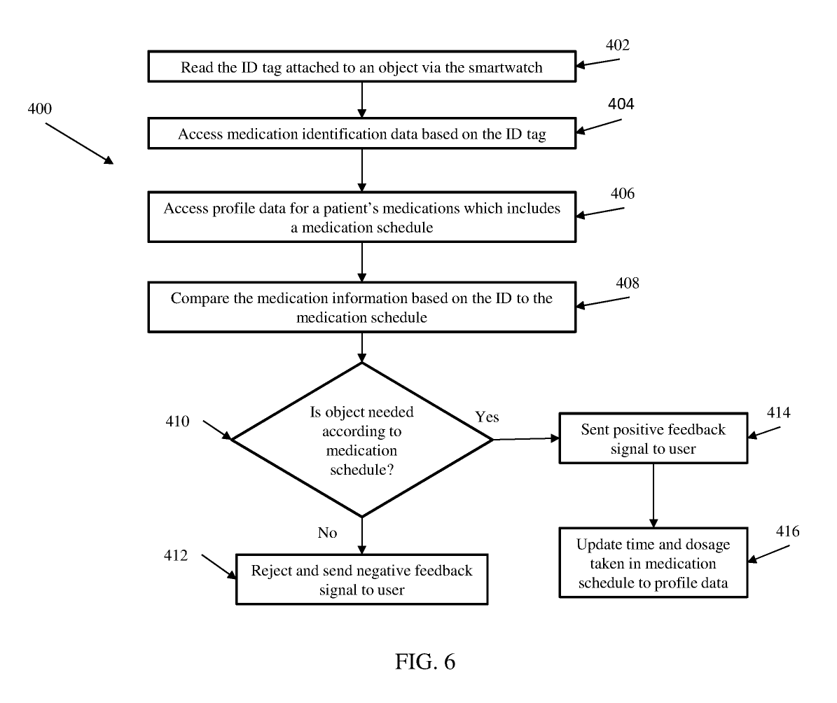

FIG. 6 is a flow diagram of an exemplary embodiment of a method 400 for providing proximity feedback for medicine identification. The method 400, at block 402, reads an ID attached to an object via a smartwatch. Next, at block 404, the method 400 accesses medication identification data based on the ID tag. At block 406, the method 400 accesses profile data for a patient's medications which includes a medication schedule. Next, at block 408, the method 400 compares the medication information based on the ID to the medication schedule. At decision block 410, the method 400 decides if the closest object is needed according to the medication schedule. If the decision is ‘No’, the object is rejected and a negative feedback signal is sent to the user, as shown in block 412. If the decision is ‘Yes’, a positive feedback signal is sent to the user, as shown at block 414. Then, at block 416, the method 400 updates the time and dosage taken in the medication schedule to the profile data.

In exemplary embodiments, the decision block 410 decides if an object is needed based upon the medication schedule that is accessed from the patient profile. Additionally, the medication identification data that is based upon the ID tag will be compared to the patient's profile which includes the medication schedule. For example, if the patient's medication schedule denotes that a patient must take a certain medication and the patient picks up the incorrect medication bottle as identified through the ID tag, a negative feedback signal will be sent to the patient via a smartwatch. An additional example, my send a positive feedback signal should the patient pick up the correct medication bottle according to the patient profile and medication schedule.

Additional processes may also be included. It should be understood that the processes depicted in FIG. 6 represent illustrations, and that other processes may be added or existing processes may be removed, modified, or rearranged without departing from the scope and spirit of the present disclosure.

In exemplary embodiments, a user of the user device 206 may be a patient, a family member or friend of the patient, or a healthcare worker. For example, a nurse in a rural community may be treating a patient and will receive a medication order from a doctor for a statin drug to lower the cholesterol for a patient. The nurse may not be familiar with this particular medication or may know it under a different name. The nurse is wearing a smartwatch that is able to read the ID on the different medications for the patient. An accelerometer on the smartwatch is able to detect the nurse picking up the bottle. The ID tag on the medication bottle is checked to identify the medication. If the ID tag identifies the correct medication, i.e. the statin drug, the smartwatch would send positive feedback to the nurse to indicate a positive match for the prescribed medication. If the ID identifies the incorrect medication, the nurse will receive a negative feedback from the smartwatch to indicate that the bottle contains the incorrect medication.

In exemplary embodiments, the user device 206 receives a patient's profile information which contains the medical history of the patient which includes a list of medications, dosage information, and drug interactions and dependencies. For example, the user of a smartwatch may download their profile data from a computing device 220 onto the smartwatch. Then, when the user interacts with an object such as a medication bottle, the smartwatch will read the ID tag 204 via its sensor 208 and compare the information found within the ID tag 204 with the patient profile to check for compliance. The compliance can be a medication schedule and/or dosage amount. For example, if a patient, in the morning, picks up a blood pressure medication bottle that is schedule for night time deliver, the smartwatch will send feedback to notify the user that this medication should not be taken at this time. When a patient does take a medication at the correct time, the profile data contained on the smartwatch is updated to reflect the user taking the dosage along with the time and date. Should the user pick up the same medication bottle on the same day, the smartwatch will notify the user, via feedback, that the user has already taken the medication dosage for that date.

In exemplary embodiments, the ID tag 204 may be a passive or an active RFID tag. The ID tag 204 may be disposed on the inside of an object 202 wherein the user device is unable to read the ID tag 204 when the object 202 is closed. For example, a prescription medicine bottle can have the ID tag 204 disposed on the inside of the bottle and the material of the bottle would obscure reading the ID tag 204 until the medication bottle's cap is removed. In embodiments, the active RFID tag may be activated via a piezoelectric circuit wherein the movement of the bottle could charge the active RFID tag for it to transmit a signal to a reader. In other embodiments, the RFID tag is a passive tag which is read by a smartwatch or other user device. The smartwatch may send out a periodic signal to read the passive RFID tag.

In additional embodiments, a patient's profile data contains a medication schedule in the form of restrictions. For example, if a medication can only be taken every four hours and the user device 206 comes within a threshold proximity of the user device 206 within the four hour period. A negative feedback signal can be sent to the user to alert the user that this medication has a time restriction associated with taking a dosage.

In exemplary embodiments, the system 200 can be implemented using a variety of technologies including an RFID tag. For example, a near field communication (NFC) protocol, a camera capable of reading a 1 dimensional or 2 dimensional bar code, or a camera configured to read the label on an object using optical character recognition (OCR) can be used for the user device 206 to retrieve information from an object 202.

In another embodiment, the system 200 may be implemented in a training scenario for multiple applications. For example, a nurse may utilize the system to train on retrieving the correct medication bottle based upon an order. The feedback from a smartphone can help guide the nurse in selecting the appropriate medication in the appropriate order for a patient.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for monitoring a user, the method comprising:
accessing, via a user device, a profile data for the user;
reading, via the user device, identification data from an identification tag on an object;
obtaining information associated with the identification data, wherein the information is associated with contents of the object; and
providing a feedback to the user via the user device, the feedback is based upon the information and an interaction between the user of the user device and the object.

2. The method according to claim 1, wherein the profile data comprises medical information about a patient.

3. The method according to claim 2, wherein the medical information about a patient comprises a medication dosage for the patient, a medication schedule for the patient, and a medication dependency data.

4. The method according to claim 1, wherein the profile data comprises at least one of a medication dosage amount, a schedule for taking the medication dosage, a quantity of a medication contained within the object; and a medication interval restriction.

5. The method according to claim 1, wherein the feedback comprises at least one of a haptic, an audio, and a visual output to the user.

6. The method according to claim 1, wherein the interaction between the user of the user device and the object comprises at least one of a proximity of the user of the user device to the object, a movement by the user of the user device with respect to the object, and a manual input from the user.

7. The method according to claim 6, wherein the movement by the user of the user device with respect to the object is determined by at least one of an accelerometer, a gyroscope, and an inclinometer contained within the user device.

8. The method according to claim 1, wherein the user comprises one of a patient, a healthcare worker, and a family member of the patient.

9. The method according to claim 1, further comprising:
updating the profile data based on the interaction between the user of the user device and the object.

10. The method according to claim 1, wherein the user device is a smartwatch.

11. A system for monitoring a user, the system comprising:
a processor configured to:
access, via a user device, a profile data for the user;
read, via the user device, identification data from an identification tag on an object;
obtain information associated with the identification data, wherein the information is associated with contents of the object; and
provide a feedback to the user via the user device, the feedback is based upon the information and an interaction between the user of the user device and the object.

12. The system according to claim 11, wherein the profile data comprises medical information about a patient.

13. The system according to claim 12, wherein the medical information about a patient comprises a medication dosage for the patient, a medication schedule for the patient, and a medication dependency data.

14. The system according to claim 11, wherein the feedback comprises at least one of a haptic, an audio, and a visual output to the user.

15. The system according to claim 11, wherein the interaction between the user of the user device and the object comprises at least one of a proximity of the user of the user device to the object, a movement by the user of the user device with respect to the object, and a manual input from the user.

16. The system according to claim 15, wherein the movement by the user of the user device with respect to the object is determined by at least one of an accelerometer, a gyroscope, and an inclinometer contained within the user device.

17. A computer program product for monitoring a user, the computer program product comprising a computer readable storage medium having program instructions embodied therewith, wherein the computer readable storage medium is not a transitory signal per se, the program instructions executable by a processor to cause the processor to perform a method comprising:
accessing, via a user device, a profile data for the user;
reading, via the user device, identification data from an identification tag on an object;
obtaining information associated with the identification data, wherein the information is associated with contents of the object; and
providing a feedback to the user via the user device, the feedback is based upon the information and an interaction between the user of the user device and the object.

18. The computer program product according to claim 17, wherein the profile data comprises medical information about a patient.

19. The computer program product according to claim 17, further comprising:
updating the profile data based on the interaction between the user of the user device and the object.

20. The computer program product according to claim 17, wherein the user comprises one of a patient, a healthcare worker, and a family member of the patient.
